(19) United States
(12) Patent Application Publication
(10) Pub. No.: US 2010/0074218 A1
(43) Pub. Date: Mar. 25, 2010

(54) METHOD AND APPARATUS FOR PILOT CAPTURE FOR WIRELESS INTERSYSTEM HANDOVER

(75) Inventors: Lingyun Cai, Shanghai (CN); Ni Ma, Shanghai (CN)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/993,606

(22) PCT Filed: Jun. 27, 2006
(86) PCT No.: PCT/IB06/52107

§ 371 Date: Dec. 21, 2007

(30) Foreign Application Priority Data
Jun. 29, 2005 (CN) 200510081082.8

(51) Int. Cl. H04W 36/00

(52) U.S. Cl. 370/331

(57) ABSTRACT

The present invention provides a method and apparatus applied to pilot capture for handover between wireless communication networks. In the method, when a mobile station needs to hand over from a GSM system serving as current service network to another wireless communication network, the GSM system and the mobile station will update the logic location of the first idle frame to be met subsequently, which will be inserted after the TDMA frame where the corresponding starting point of pilot capture resides, then the mobile station utilizes idle timeslots after the starting point to form a pilot capture time window with a predefined length, eventually the mobile station captures the pilot signal of the another wireless communication network in the pilot capture time window. Comparing to conventional pilot capture method, with the method provided by the present invention, the mobile station not only capture the complete pilot signal of target handover network, but also achieve the whole pilot-capture process with relatively short time.

### FIELD OF THE INVENTION

The present invention relates generally to wireless communication networks, and more particularly, to a method and apparatus applied to pilot capture for handover between wireless communication networks.

### BACKGROUND OF THE INVENTION

GSM is one of widely used cellular wireless communication networks at present. It provides excellent quality for voice service, but its capability for data communication is relatively weak. Therefore, some wireless communication networks which could provide outstanding data communication service are proposed, e.g. TD-SCDMA, CDMA2000 and WCDMA, etc. Since GSM and these wireless communication networks have distinctive features respectively, they will inevitably co-exist in real applications. Therefore, it is necessary for a mobile station (MS) to hand over freely between GSM and these wireless communication networks, so that a user can enjoy the services provided by GSM and these wireless communication networks.

FIG. 1 shows the existing procedure of handover from GSM to TD-SCDMA system. As shown in FIG. 1, the mobile station currently served by GSM sends a measurement report to a base station controller (BSC_{old}) in GSM via a base transceiver station (BTS_{old}) in GSM. Based on the received measurement report, BSC_{old} makes decision whether the mobile station needs to hand over to TD-SCDMA system. When handover is required, BSC_{old} sends a handover request to a base station (NodeB_{new}) in TD-SCDMA system via a mobile station center (MSC_{old}) in GSM and a radio network controller (RNC_{new}) in TD-SCDMA system. According to the handover request, NodeB_{new} allocates wireless resources to a mobile station and sends a request acknowledgement to RNC_{new}. According to the request acknowledgement, RNC_{new} sends a handover command to the mobile station via MSC_{old}, BSC_{old} and BTS_{old}. According to the handover command, the mobile station accesses to NodeB_{new} in TD-SCDMA system via a random access channel (RACH) and establishes a communication link with NodeB_{new}. And then, NodeB_{new} informs RNC_{new}, MSC_{old}, BSC_{old} and BTS_{old} that the handover is completed, subsequently, MSC_{old} reclaims the wireless resources allocated to the mobile station by GSM.

When conducting the above-mentioned handover, the mobile station needs to capture a pilot signal of TD-SCDMA system before handing over from GSM to TD-SCDMA, so that the mobile station can establish synchronization with TD-SCDMA system.

It is well-known that each sub-frame in TD-SCDMA protocols contains a pilot timeslot DwPTS dedicated for downlink synchronization, shown in FIG. 2, and the pilot signal in TD-SCDMA system is exactly carried in DwPTS. Therefore, to capture the pilot signal of TD-SCDMA means to capture the pilot signal carried in DwPTS.

In GSM, the mobile station normally uses a pilot capture time window comprising four idle timeslots to capture the pilot signal in TD-SCDMA system.

FIG. 3 shows a schematic diagram of the four idle timeslots that comprises the pilot capture time window, wherein it is assumed that GSM system allocates the timeslot TS1 in each TDMA frame to the mobile station for communication with the base station. Shown in FIG. 3, since in GSM, the uplink TDMA frame is lagged 3 timeslots behind the same TDMA downlink frame, the mobile station can have at most four idle timeslots between the time where the mobile station sends signals to the base station via TS1 and the time where the base station subsequently sends signals to the mobile station via TS1.

The length of one timeslot in TDMA frame is 15/26 ms, therefore the duration of four idle timeslots is roughly 2.3 ms. However, the time interval between any two adjacent DwPTS in TD-SCDMA system is 5 ms, therefore, it is difficult for the mobile station to capture the pilot signal of DwPTS within only 4 idle timeslots. Moreover, when capturing the pilot signal, even though DwPTS is exactly located within the time zone covered by the four idle timeslots, not all the mobile stations can utilize the pilot capture time window comprising four idle timeslots to capture the complete pilot signal of TD-SCDMA system.

3GPP TS 25.225 V5.0.0 (2002-03): Physical layer-Measures (TDD) (Release 5) specifies the minimum time required to capture the complete pilot signal in DwPTS, which can be calculated according to the following equation (1),

t_{min,guaranteed}=2×t_{synth}+T_{DwPTS}+t_{offset} (1)

wherein T_{DwPTS} (=0.275 ms) is the duration of the target pilot signal and t_{offset} is the offset between the frame in GSM and the sub-frame in TD-SCDMA system, which is

$$\frac{{T}_{TDMA frame}}{12} = \frac{60}{13} / 12 = \frac{5}{13} ( ms )$$

since the 12 TD-SCDMA frames equal to the 13 GSM frames.

t_{synth} is the period required to conduct a frequency switching between GSM and TD-SCDMA by the synthesizer of the mobile station that uses only one signal transceiver to transmit/receive signals. In each time for pilot capture, the mobile station needs to switch frequency from GSM to TD-SCDMA and then back to GSM again, therefore the mobile station needs 2 t_{synth} to capture the pilot signal each time. For different mobile stations, the range of t_{synth} varies from 0.2 ms to 0.8 ms. When t_{synth}=0.8 ms, t_{min, guranteed} is calculated as follows:

t_{min,guaranteed}=2×0.8+0.275+5/13=2.360(ms) (2)

From the equation 2, since the duration of each time slot in GSM is 15/26 ms, t_{min, guaranteed} approximates to the length of 5 timeslots. Obviously, in case of t_{synth}=0.8 ms, 4 idle timeslots cannot satisfy the minimum time requirement to capture the complete pilot signal in TD-SCDMA system.

In this case, an idle frame in GSM is required to capture the complete pilot signal. As shown in FIG. 4, a multiframe in GSM comprises 26 TDMA frames, wherein 1^{st}-12^{th} and 14^{th}-25^{th} TDMA frames are designated as a traffic channel (TCH), 13^{th} TDMA frame is designated as a slow associated control channel (SACCH), and 26^{th} TDMA frame is designated as an idle frame (--). One idle frame has 8 idle timeslots, and its total duration is 4.6 ms, which approximates to the time interval between two adjacent DwPTSs in TD-SCDMA, namely 5 ms, so it is easy to capture the complete pilot signal in TD-SCDMA system using the idle frame. However, since the starting point to capture pilot signal is random, and each multiframe has only one idle frame and the location of the idle frame is fixed, the time required to capture the pilot signal with the idle frame is varying. The expectation and variance of the capture time are respectively defined by

t̅=E[t] (3)

σ _{t̅}=\sqrt{E[t²]−E²[t]} (4)

Wherein t=i×T_{TDMA frame} is the capture time, i (1≦i≦26, iεN) represents that when the capture of the pilot signal begins, DwPTS is located within the i^{th} TDMA frame starting from the idle frame in multiframe. It is assumed that p(i) is the probability that DwPTS is located within the i^{th} TDMA frame starting from the idle frame in multiframe when the capture of the pilot signal begins, then,

$$\begin{matrix}\begin{matrix}\overline{t} = \sum t \cdot p ( t ) \\ = {\sum }_{i = 1}^{26} i \cdot \cdot p ( i ) \\ = {\sum }_{i = 1}^{26} \frac{4.616 i}{26} \\ = 62.316 ( ms )\end{matrix} & ( 5 ) \\ \begin{matrix}{σ}_{i} = \sqrt{\sum {t}^{2} \cdot p ( t ) - {t}^{- 2}} \\ = \sqrt{{\sum }_{i - 1}^{M} {( i \cdot )}^{2} \cdot p ( i ) - {t}^{- 2}} \\ = \sqrt{{\sum }_{i - 1}^{26} {( 4.616 i )}^{2} \cdot p ( i ) - {t}^{- 2}} \\ = 34.62 ( ms )\end{matrix} & ( 6 )\end{matrix}$$

As shown in the equation 5 and 6, the time required from the starting of the capture of the pilot signal in TD-SCDMA to the completion of the capture varies from t̅−σᵢ(=27.696 ms) to t̅+σᵢ(=96.936 ms), approximately 6˜21 TDMA frames, which is time consuming.

When the target handover system is not TD-SCDMA but other cellular mobile system that also utilizes timeslots to send the pilot signal, e.g., WCDMA or CDMA 2000, they have the above problem.

Therefore, a method and apparatus applied to pilot capture for handover in the wireless communication network is needed for the mobile station to capture the pilot signal of the target handover system quickly.

### OBJECT AND SUMMARY OF THE INVENTION

An object of the present invention is to provide a method and apparatus applied to pilot capture for handover in the wireless communication network. Using the method and apparatus, the mobile station not only can capture the complete pilot information of target handover network, but also can achieve the whole pilot-capture process with relatively short time.

In order to realize the object of the present invention, according to the present invention, a method for capturing a pilot signal intended to be executed by a mobile station during handover between wireless communication networks, the method comprising the steps of:

(a) Receiving an idle frame logic location update message sending from a current service network;

(b) Adjusting a logic location of a first idle frame to be met subsequently according to the idle frame logic location update message, to generate a pilot capture time window with a predefined length; and

(c) Capturing the pilot signal of a target handover network by using the pilot capture time window.

A method applied to a wireless communication network for pilot capture for handover between wireless communication networks, the method comprising the steps of:
(a) Sending an idle frame logic location update message to a mobile station; and
(b) Adjusting a logic location of a first idle frame to be met subsequently for the mobile station.

In order to realize the object of the present invention, a mobile station, comprising,

A receiving unit, for receiving an idle frame logic location update message from a current service network;

An adjusting unit, for adjusting a logic location of a first idle frame to be met subsequently according to the idle frame logic location update message, to generate a pilot capture time window with a predefined length; and

A capturing unit, for capturing the pilot signal of a target handover network by using the pilot capture time window.

In order to realize the object, a wireless communication network serving a mobile station, comprising:

A sending unit, for sending an idle frame logic location update message to the mobile station; and

An adjusting unit, for adjusting a logic location of a first idle frame to be met subsequently for the mobile station; and

A receiving unit, for receiving a pilot capture failure message from the mobile station.

Other objects and attainments together with a fuller understanding of the invention will become apparent and appreciated by referring to the following descriptions and claims taken in conjunction with the accompanying drawings.

### BRIEF DESCRIPTION OF THE DRAWINGS

FIG. 1 is a schematic diagram showing the existing procedure of handover from GSM to TD-SCDMA by a mobile station;

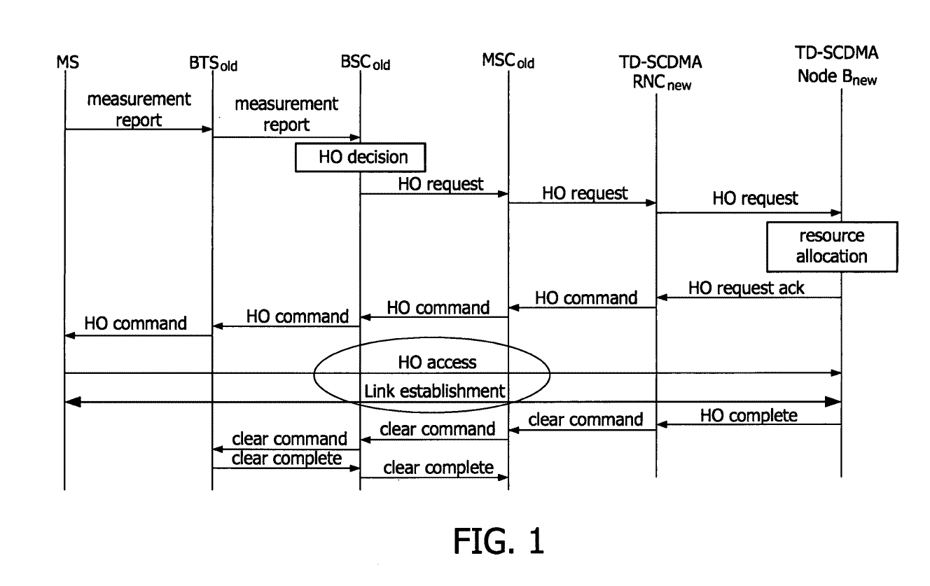

FIG. 2 is a schematic diagram showing the sub-frame structure in TD-SCDMA protocol;

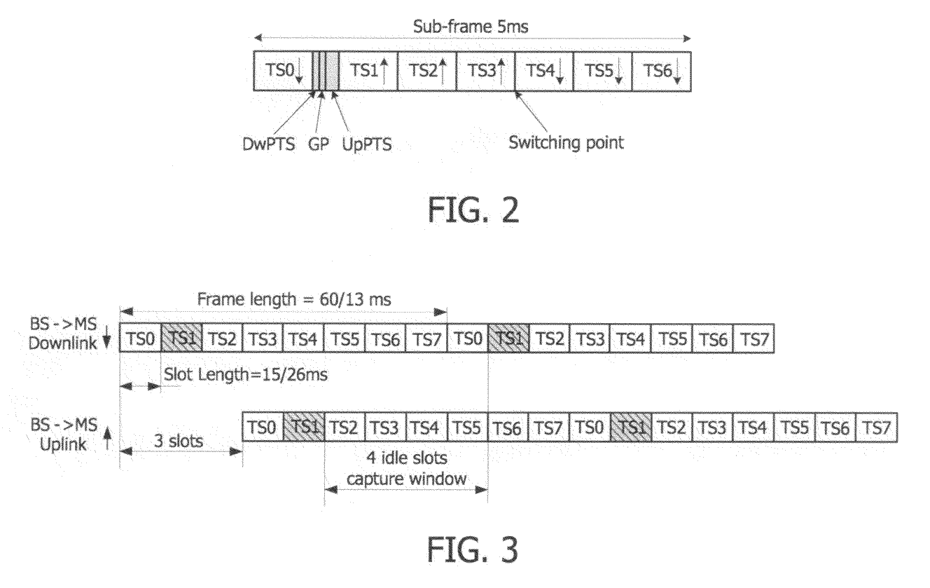

FIG. 3 is a schematic diagram showing 4 idle timeslots in GSM;

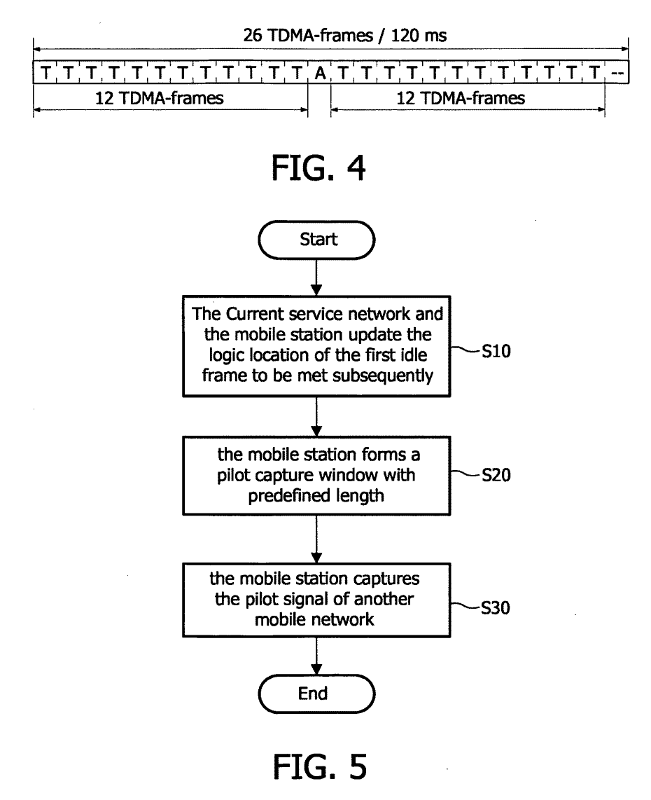

FIG. 4 is a schematic diagram showing the structure of the multiframe in GSM, wherein, T denotes a traffic channel, A denotes a slow associated control channel (SACCH), -- denotes an idle frame;

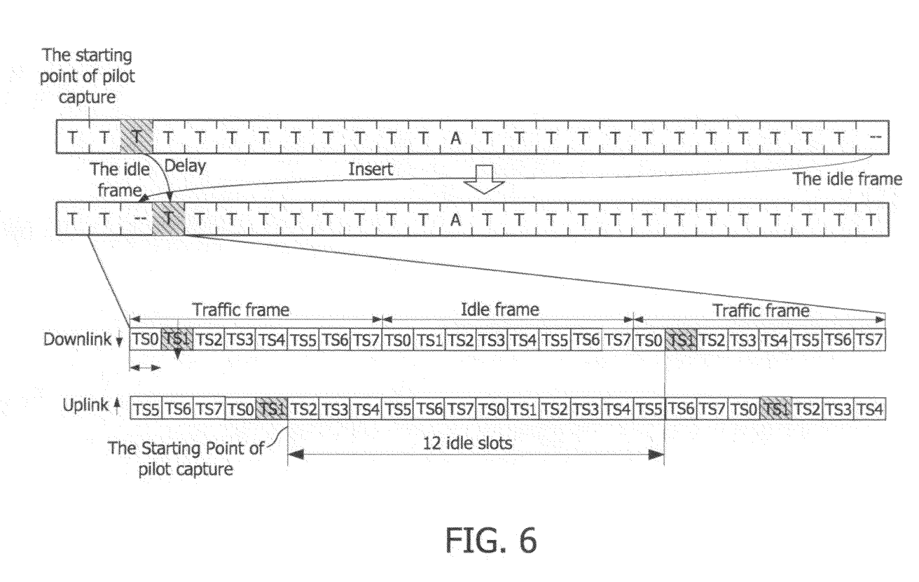

FIG. 5 is a general flowchart showing the pilot capture method according to an embodiment of the present invention

FIG. 6 is a schematic diagram showing the logic location update of GSM idle frame according to an embodiment of the present invention

FIG. 7 is a detailed flowchart showing the pilot capture method according to an embodiment of the present invention

FIG. 8 is a schematic diagram showing the conventional pilot capture method and the method provided by the present invention

FIG. 9 is a block diagram showing the mobile station and the mobile network according to an embodiment of the present invention

Throughout the drawing figures, like reference numerals will be understood to refer to like parts and components.

### DETAILED DESCRIPTION OF THE INVENTION

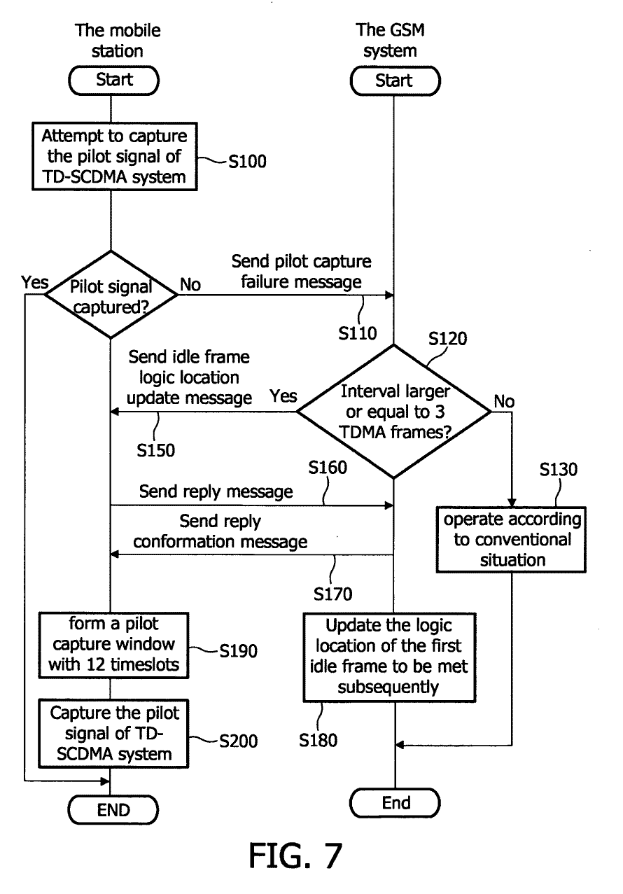

FIG. 5 is the general flowchart illustrating the method applied to pilot capture for handover according to the present invention. As shown in FIG. 5, when a mobile station needs to hand over from GSM serving as current service network to another cellular mobile network, the GSM system and the mobile station will update the logic location of the first idle frame to be met subsequently, which is inserted after a TDMA frame where the corresponding starting point of pilot capture resides (step S10), and then, the mobile station utilizes idle timeslots after the corresponding starting point of pilot capture to generate a pilot capture time window with a predefined length (step S20), eventually, the mobile station captures the pilot signal of the another cellular mobile network in the generated pilot capture time window (step S30)

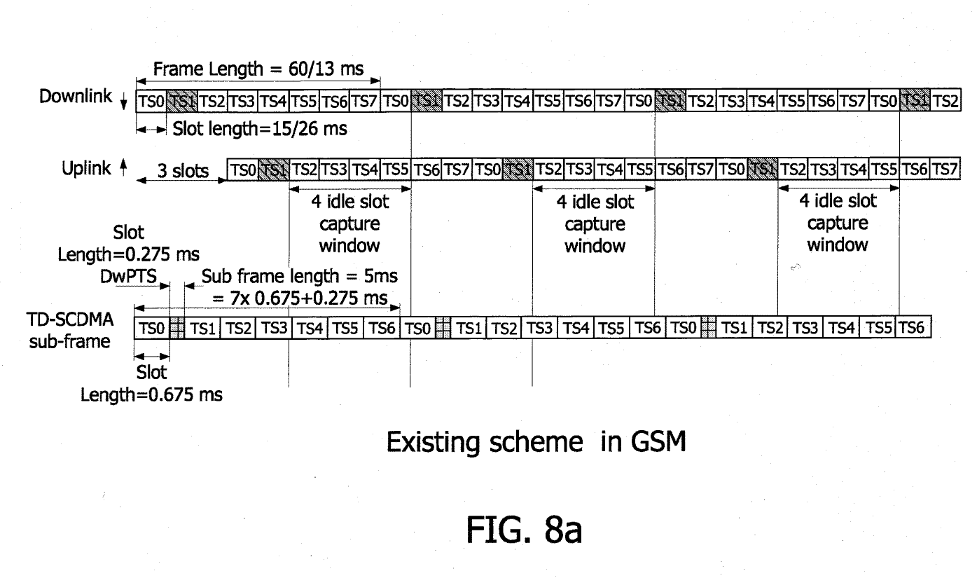

FIG. 6 is a schematic diagram showing the logic location update of GSM idle frame according to the present invention. As shown in FIG. 6, the GSM system and the mobile station update the logic location of the first idle frame to be met subsequently, which is inserted after a TDMA frame where the corresponding starting point of pilot capture resides. Thus, there are 12 idle timeslots after the corresponding starting point of pilot capture, and the mobile station can utilize the 12 idle timeslots to generate a pilot capture time window. Further, the mobile station may utilize the pilot capture time window to capture the pilot signal of another cellular mobile network that the mobile station expects to hand over.

The present invention is specifically suitable for capturing the pilot signal of the cellular mobile networks that transmits the pilot information in a timeslot. Therefore, all the pilot signal of TD-SCDMA, CDMA2000, CDMA IS-95 and WCDMA can be captured by the pilot capture method provided by the present invention.

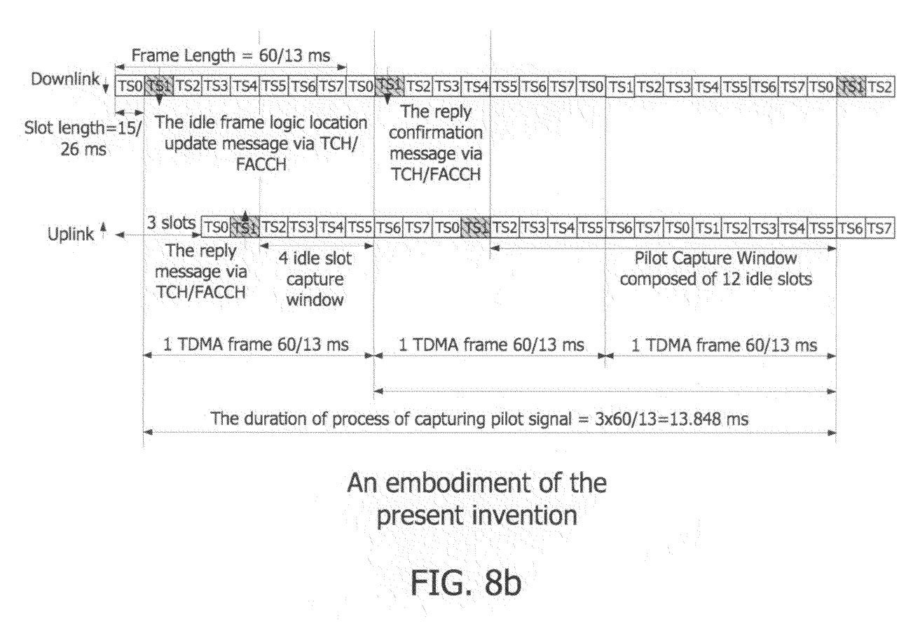

For the simplicity of illustration, the following will take a mobile station handing over from GSM to TD-SCDMA as an example to illustrate the method applied to pilot capture for handover in the wireless communication network according to an embodiment of the present invention in conjunction with FIG. 7.

When the GSM system serving as current service network determines that a mobile station should hand over from GSM to TD-SCDMA, the mobile station will first utilize a pilot capture time window comprising four idle timeslots after the first starting point of pilot capture, to attempt to capture the pilot signal of TD-SCDMA system, namely, the pilot signal transmitted by the TD-SCDMA system via DwPTS (step S100).

If the mobile station captures the complete pilot signal of TD-SCDMA system by the pilot capture time window comprising four idle timeslots, the pilot capture is ended.

If the mobile station can't capture the complete pilot signal of TD-SCDMA system by the pilot capture time window comprising four idle timeslots, the mobile station sends a pilot capture failure message to the GSM system via a fast associated control channel (FACCH) corresponding to its traffic channel (TCH) when it sends traffic data to the GSM system via its traffic channel (step S110).

Upon receiving the pilot capture failure message, the GSM system judges whether or not the time interval between the first idle frame to be met subsequently and the TDMA frame where the first starting point of pilot capture resides is larger or equal to the length of 3 TDMA frames (step S120). As described below, in this embodiment, only when the GSM system confirms that the mobile station has received a idle frame logic location update message sent by the GSM system, the GSM system can update the logic location of the idle frame, and only when the mobile station confirms that the GSM system has updated the logic location of the idle frame, the mobile station can generate a large pilot capture time window. Therefore, It requires at least three signaling exchanges between the GSM system and the mobile station. In the present embodiment, since the signaling between the GSM system and the mobile station is transmitted by the FACCH corresponding to the TCH of the mobile station, the three signaling exchanges requires the time of two TDMA frames. Therefore, the GSM system judges whether it is required for updating the logic location of the idle frame, based on whether or not the time interval between the first idle frame to be met after receiving the pilot capture failure message and the TDMA frame where the first starting point of pilot capture resides is larger or equal to the time of 3 TDMA frames.

If it is judged that the time interval is less than the duration of 3 TDMA frames, the GSM system operates normally, that is, it doesn't update the logic location of the first idle frame to be met subsequently. (Step S130)

If it is judged that the time interval is longer than the time of 3 TDMA frames, the GSM system sends an idle frame logic location update message to the mobile station via the fast associated control channel (FACCH) corresponding to the traffic channel of the mobile station (TCH) while it sends traffic data to the mobile station via the traffic channel of the mobile station (step S150).

After the mobile station receives the idle frame logic location update message from the GSM system via the FACCH corresponding to the traffic channel of the mobile station, while sending traffic data to the GSM system via its traffic channel, the mobile station sends a reply message to the GSM system via the FACCH corresponding to its traffic channel, to inform the GSM system that the idle frame logic location update message is received. (Step S160)

After the GSM system receives the reply message from the mobile station via FACCH corresponding to the traffic channel of the mobile station, while the GSM system sends traffic data to the mobile station via the traffic channel of the mobile station, the GSM system sends a reply confirmation message to the mobile station via the FACCH corresponding to the traffic channel of the mobile station (step S170), and updates the logic location of the first idle frame to be met subsequently, which is inserted after a TDMA frame where the first starting point of pilot capture resides, thus there are 12 idle timeslots after the first starting point of pilot capture, shown in FIG. 6 (step S180).

After Receiving the reply confirmation from the GSM system via the FACCH corresponding to its traffic channel, the mobile station updates the logic location of the first idle frame to be met subsequently, which is inserted after a TDMA frame where the first starting point of pilot capture resides, to generate a pilot capture time window with the 12 idle timeslots after the first starting point of pilot capture (step S180).

The mobile station captures the pilot signal of TD-SCDMA system in the generated pilot capture time window (step S200).

The method applied to pilot capture for handover in the wireless communication network according to an embodiment of the present invention is described above in conjunction with FIG. 7. Wherein, the GSM system updates the logic location of the idle frame after receiving the reply message from the mobile station, which ensures the GSM system not to update the logic location of the idle frame under the condition that the mobile station doesn't receive the idle frame logic location update message, so as to prevent improper operation.

In another embodiment of the present invention, when the channel situation makes the mobile station certainly receive the idle frame logic location update message from the GSM system (e.g. the ratio of signal to noise is larger than a predefined threshold), after sending the idle frame logic location update message to the mobile station, the GSM system updates the logic location of the first idle frame to be met subsequently, which is inserted after the TDMA frame where the first starting point of pilot capture resides, the first starting point being first met after the idle frame logic location update message is sent. Therefore, when receiving the idle frame logic location update message from the GSM system, the mobile station updates the logic location of the first idle frame to be met subsequently, which is inserted after the TDMA frame where the first starting point of pilot capture resides, the first starting point being first met after the idle frame logic location update message is sent, so as to utilize idle timeslots after the first starting point of pilot capture to generate a large pilot capture time window.

Moreover, in yet another embodiment of the present invention, there is no need for the GSM system to send the idle frame logic location update message after receiving the pilot capture failure information from the mobile station, in contrast, when determining that the mobile station must hand over from GSM to the TD-SCDMA, the GSM system may send the idle frame logic location update message to the mobile station.

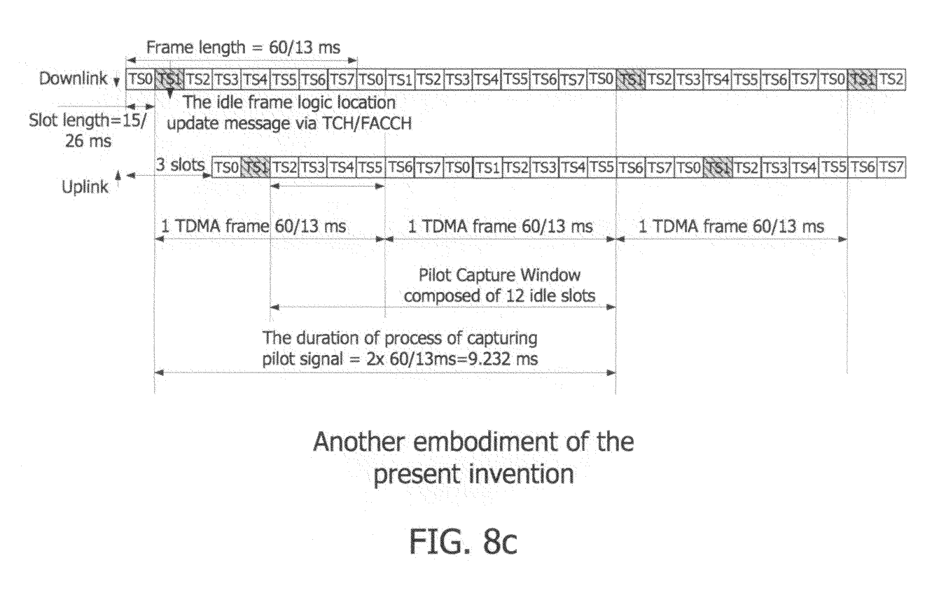

FIG. 8 is a schematic diagram showing the conventional pilot capture method and the method provided in the present invention, wherein, the GSM system allocates the timeslot TS1 in each TDMA frame to the mobile station for communication, and the pilot signal is transmitted on DwPTS in each sub-frame of TD-SCDMA system.

As shown in FIG. 8, when the conventional pilot capture method is employed to capture the pilot signal of TD-SCDMA system, since DwPTS in TD-SCDMA system is not located within the coverage of the conventional pilot capture time window comprising four idle timeslots during 3 TDMA frames, the conventional pilot capture method can not capture the pilot signal in DwPTS within 3 TDMA frames.

According to an embodiment in the present invention, the complete pilot capture process from beginning till the pilot signal in TD-SCDMA system is captured, comprising: firstly, the GSM system sends an idle frame logic location update message; then the mobile station receives the idle frame logic location update message and sends a reply message; next, the GSM system receives the reply message, sends a reply confirmation message and update the logic location of the first idle frame to be met subsequently; finally, after receiving the reply confirmation message, the mobile station updates the logic location of the first idle frame to be met subsequently to utilize a pilot capture time window formed by 12 idle timeslots after the first starting point of pilot capture to capture the pilot signal in DwPTS, which only lasts the length of 3 TDMA frames, namely t=3×T_{TDMA FRAME}=3×60/13=13.848 ms.

According to another embodiment of the present invention, when the channel situation makes the mobile station certainly receive the idle frame logic location update message from the GSM system (e.g. the ratio of signal to noise is larger than a predefined threshold), the complete pilot capture process from beginning till the pilot signal in TD-SCDMA system is captured, comprising: firstly, the GSM system sends the idle frame logic location update message and updates the logic location of the first idle frame to be met subsequently; then after receiving the idle frame logic location update message, the mobile station updates the logic location of the first idle frame to be met subsequently, so as to utilize a pilot capture time window formed by 12 idle timeslots after the first starting point of pilot capture to capture the pilot signal in DwPTS, which only lasts the length of 2 TDMA frames, namely t=2×T_{TDMA FRAME}=2×60/13=9.232 ms.

As to the above method applied to pilot capture for handover as provided in the present invention, it can be implemented in software or hardware, or in combination of both.

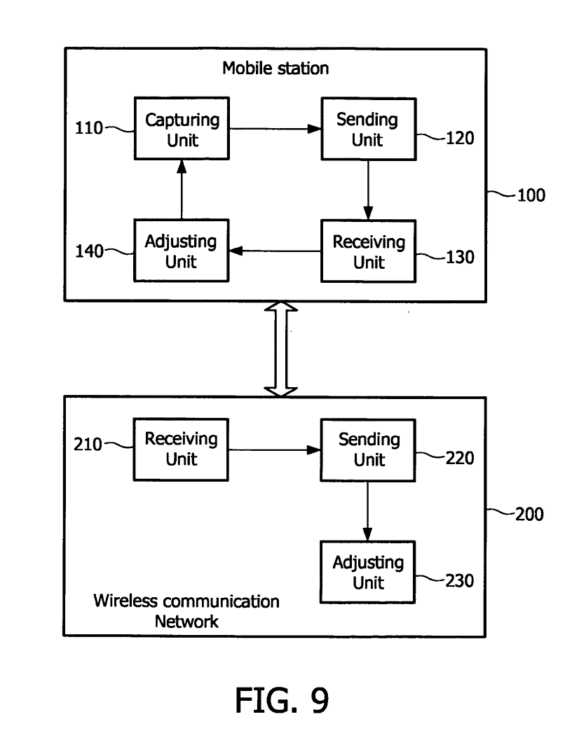

FIG. 9 is a block diagram showing a mobile station and a wireless communication network according to an embodiment of the present invention, in which only the mobile station 100 and the wireless communication network 200 that provide service to the mobile station 100 are shown.

As shown in FIG. 9, in the mobile station 100, a capturing unit 110 attempts to capture pilot signal of a target handover network (e.g., TD-SCDMA) by utilizing a pilot capture time window comprising idle timeslots between uplink timeslots and downlink timeslots. When the pilot signal of the target handover network is not captured, a sending unit 120 sends a pilot capture failure message to the wireless communication network 200 via a FACCH corresponding to a traffic channel of the mobile station 100. A receiving unit 130 receives an idle frame logic location update message from the wireless communication network 200 and for the mobile station via the FACCH corresponding to the traffic channel of the mobile station. According to the idle frame logic location update message, an adjusting unit 140 adjusts the logic location of the first idle frame to be met subsequently, so as to generate a pilot capture time window with a predefined length. The capturing unit 110 captures the pilot signal of the target handover network by using the pilot capture time window.

In the wireless communication network 200 that provides service to the mobile station 100 (e.g., the GSM system), a receiving unit 210 receives the pilot capture failure message from the mobile station 100 via the FACCH corresponding to the traffic channel of the mobile station. After receiving the pilot capture failure message, a sending unit 220 sends the idle frame logic location update message to the pilot capture 100 via the FACCH corresponding to the traffic channel of the mobile station. An adjusting unit 230 adjusts the logic location of the first idle frame to be met subsequently for the mobile station 100.

### ADVANTAGES OF THE INVENTION

As described above, according to the present invention in conjunction with figures, it can be concluded that in the method and apparatus of the present invention, the GSM system serving as current service network and the mobile station update the logic location of the idle frame, which is inserted after a TDMA frame where the first starting point of pilot capture resides, so that the mobile station can utilize idle timeslots after the corresponding starting point to generate a large pilot capture time window and capture pilot signal of a target handover system by using the window. Therefore, comparing to conventional pilot capture methods, the pilot capture method according to the present invention can not only capture the pilot signal of the target handover system, but also make the duration of pilot capture process relatively short.

It is to be understood by those skilled in the art that the method and apparatus applied to pilot capture for handover as provided in the present invention where handover from GSM to TS-SCDMA is taken as an example, can also apply to the handover from GSM to WCDMA, CDMA IS-95 or CDMA2000, etc.

It is to be understood by those skilled in the art that the method and apparatus applied to pilot capture for handover as disclosed in this invention can be made of various modifications without departing from the spirit and scope of the invention as defined by the appended claims.

1. A method for capturing a pilot signal intended to be executed by a mobile station during handover between wireless communication networks, the method comprising the steps of:
(a) Receiving an idle frame logic location update message sending from a current service network;
(b) Adjusting a logic location of a first idle frame to be met subsequently according to the idle frame logic location update message, to generate a pilot capture time window with a predefined length; and
(c) Capturing the pilot signal of a target handover network by using the pilot capture time window.

2. The method according to claim 1, further comprising before the step (a):
Attempting to capture the pilot signal of the target handover network by using the pilot capture time window comprising idle timeslots between uplink timeslots and downlink timeslots; and
Sending a pilot capture failure message to the current service network, when not capturing the pilot signal of the target handover network.

3. The method according to claim 1, wherein the idle frame logic location update message is receiving and the pilot capture failure message is sending via a fast associated control channel corresponding to a traffic channel of the mobile station.

4. The method according to claim 3, wherein the current service network is a GSM system.

5. The method according to claim 4, wherein the target handover network is a TD-SCDMA system.

6. A method applied to a wireless communication network for pilot capture for handover between wireless communication networks, the method comprising the steps of:
(a) Sending an idle frame logic location update message to a mobile station; and
(b) Adjusting a logic location of a first idle frame to be met subsequently for the mobile station.

7. The method according to claim 6, further comprising receiving a pilot capture failure message from the mobile station before the step (a).

8. The method according to claim 6, wherein the idle frame logic location update message is sending from the current service network or the pilot capture failure message is receiving via a fast associated control channel corresponding to a traffic channel of the mobile station.

9. The method according to claim 8, wherein the current service network is a GSM system.

10. The method according to claim 9, wherein the target handover network is a TD-SCDMA system.

11. A mobile station, comprising,
A receiving unit, for receiving an idle frame logic location update message from a current service network;
An adjusting unit, for adjusting a logic location of a first idle frame to be met subsequently according to the idle frame logic location update message, to generate a pilot capture time window with a predefined length; and
A capturing unit, for capturing the pilot signal of a target handover network by using the pilot capture time window.

12. The mobile station according to claim 11, further comprising
The capturing unit, for attempting to capture the pilot signal of the target handover network by using the pilot capture time window composed of idle timeslots between uplink timeslots and downlink timeslots; and
A sending unit, for sending a pilot capture failure message to the current service network when the pilot signal of the target handover network is not captured.

13. The mobile station according to claim 11, wherein the mobile station receives the idle frame logic location update message and sends the pilot capture failure message via a fast associated control channel corresponding to a traffic channel of the mobile station.

14. The mobile station according to claim 13, wherein the current service network is a GSM system.

15. The mobile station according to claim 14, wherein, the target handover network is a TD-SCDMA system.

16. A wireless communication network serving a mobile station, comprising:
A sending unit, for sending an idle frame logic location update message to the mobile station; and
An adjusting unit, for adjusting a logic location of a first idle frame to be met subsequently for the mobile station; and
A receiving unit, for receiving a pilot capture failure message from the mobile station.

17. The wireless communication network according to claim 16, wherein the wireless communication network sends the idle frame logic location update message or receives the pilot capture failure message via a fast associated control channel corresponding to a traffic channel of the mobile station.

18. The wireless communication network according to claim 17, wherein the wireless communication network is a GSM system.

19. The wireless communication network according to claim 18, wherein, the target handover network is a TD-SCDMA system.
